(19) United States
(12) Patent Application Publication
(10) Pub. No.: US 2016/0203462 A1
(43) Pub. Date: Jul. 14, 2016

(54) Method for sharing sale proceeds from E-commerce seller of mobile application

(71) Applicant: Beijing Jinher Software Co., Ltd., Beijing (CN)

(72) Inventor: Runfeng LUAN, Beijing (CN)

(21) Appl. No.: 14/594,177

(22) Filed: Jan. 12, 2015

(51) Int. Cl. G06Q 20/22

(52) U.S. Cl. CPC G06Q 20/29

(57) ABSTRACT

The present invention discloses a method for sharing sale proceeds from an E-commerce seller of a mobile application, comprising: presenting a sale request of a product from an E-commerce seller through a mobile application on a mobile terminal; enabling a user of the mobile terminal to purchase the product in the mobile application, and calculating a cumulative amount of money spent by the user on the product through the mobile application; when the cumulative amount reaches a predetermined value, examining a rank of the user compared with other users at a time the cumulative amount reaches the predetermined value, and if the rank is within a predetermined range, taking a first proportion of sales amount of the product as proceeds every day, and packaging the proceeds into an account of the user in the mobile application; only if the user logs on the mobile application and clicks on the proceeds package every day, enabling the user to finally obtain the proceeds, and recording the proceeds in the account in the mobile application. Through the method, a part of sale proceeds may be distributed to buyers and forwarders of sale information, and buyers and forwarders of sale information need to log on the application account to practically obtain the proceeds, so user activity of the mobile application platform may be ensured.

### CROSS-REFERENCE TO RELATED APPLICATION

This application claims the priority benefit of Chinese patent application No.201510001737X, filed Jan. 4, 2015. The entirety of the above-mentioned patent application is hereby incorporated by reference herein and made a part of specification.

### TECHNICAL FIELD

The present invention relates to method of sale proceeds of E-commerce, and more particularly, to a method for sharing sale proceeds from an E-commerce seller of a mobile application.

### BACKGROUND

With development of Internet and E-commerce technology, more and more people shop and make expenditure online. Not only shopping online is convenient and speedy, but also goods available online are extremely rich in variety and quantity, with numerous sellers providing more options for consumers with massive commodities. What is most valuable is experience information from users, such as use reports, evaluation, scoring and the like from users. However, a customer needs to search to target a product, and then review evaluation of the product. In this regard, a rebate mode may be devised to promote products as another low-cost advertisement.

Traditional product sales on a network platform directly sell all kinds of goods on an application platform. A user simply purchases and makes payment on a mobile terminal, which accounts for one transaction. This method may only provide proceeds from an individual customer for the E-commerce seller, without producing an advertising effect. Another mode involves sale advertisements, in which, an E-commerce seller negotiates about advertisements with various mobile platforms, and releases advertisements in mobile applications. In this mode, E-commerce sellers still face a lot of challenges, among which is that users of mobile applications generally consider advertisements annoying and resist this mode. More notably, app users rarely or never have incentives to browse advertisements.

Accordingly, in order to overcome defects in the related art, a method for sharing sale proceeds from an E-commerce seller of a mobile application may be provided to address the above-mentioned issues.

### SUMMARY

One object of the present invention is to overcome at least the above issues and defects, and to provide at least advantages given below.

Another object of the present invention is to provide a method for sharing sale proceeds from an E-commerce seller of a mobile application, which enables purchasers who purchase in the mobile applications and sharers who share the mobile application to obtain proceeds.

Another object of the present invention is to promote a mobile application and a product at a low cost by sharing sale proceeds from an E-commerce seller of the mobile application, in order to obtain a better sales amount.

Another object of the present invention is to enhance popularity of a mobile application by encouraging customers to log on the mobile application.

In order to achieve these objects and other advantages, a method for sharing sale proceeds from an E-commerce seller of a mobile application is provided, comprising:

presenting a sale request of a product from an E-commerce seller through a mobile application on a mobile terminal;

enabling a user of the mobile terminal to purchase the product in the mobile application, and calculating a cumulative amount of money spent by the user on the product through the mobile application;

when the cumulative amount reaches a predetermined value, examining a rank of the user compared with other users at a time the cumulative amount reaches the predetermined value, and if the rank is within a predetermined range, taking a first proportion of sales amount of the product as proceeds every day, and packaging the proceeds into an account of the user in the mobile application;

only if the user logs on the mobile application and clicks on the proceeds package every day, enabling the user to finally obtain the proceeds, and recording the proceeds in the account in the mobile application; and if the user does not click on the proceeds package, disabling the user to practically obtain the proceeds of that day.

Preferably, wherein, mobile applications of all E-commerce sellers belong to a same mobile application platform, and the said mobile application platform deducts in advance a second proportion of a sales amount of each successful transaction from each E-commerce seller thereon, as a proceeds distribution amount, and then distributes the proceeds distribution amount to an account of each mobile application, wherein, the second proportion is larger than the first proportion.

Preferably, wherein, the first proportion is ten thousandths; the predetermined range is former 300 persons; and the second proportion is three percent.

Preferably, wherein, the user is enabled to keep obtaining the proceeds until the product is not on sale any more.

The objects of the present invention may be achieved by a method for sharing sale proceeds from an E-commerce seller of a mobile application, comprising:

representing a sale request of a product from an E-commerce seller through a mobile application on a mobile terminal;

enabling the user of the mobile terminal to forward the sale request to mobile applications of other types than that of the mobile application;

the sale request received by the mobile applications of other types containing a link to a sale interface for performing a direct purchase operation;

if a purchase transaction is successful, taking a first proportion of sales amount of the product as proceeds, and packaging the proceeds into an account of the user who has performed the forwarding operation in the mobile application;

only if the user logs on the mobile application or a background interface and clicks on the proceeds package, enabling the user to finally obtain the proceeds, and recording the proceeds in the account in the mobile application or the background interface; and if the user does not click on the proceeds package, disabling the user to practically obtain the proceeds.

Preferably, wherein, mobile applications of all E-commerce sellers belong to a same mobile application platform, and when the user of the mobile terminal forwards the sale request, the said mobile application platform records information on the user who has performed the forwarding operation, so as to distribute proceeds to the user after a purchase transaction is successful.

Preferably, wherein, a sale request which has been forwarded to mobile applications of other types is forwarded further, after a purchase operation on a sale request that has been forwarded further, a first proportion of sales amount of the product is packaged as proceeds into an account of the user who has performed the further forwarding operation in the mobile application, and the user who has performed the first forwarding operation is disabled to obtain the proceeds.

Preferably, wherein, the mobile application is provided with a functional model for directly forwarding to other mobile applications.

Preferably, wherein, the mobile applications of other types comprise WeChat and Microblog.

Preferably, wherein, the sale request received by mobile applications of other types also contains a registration interface, and when a sale request which has been forwarded to mobile applications of other types is forwarded further, a registration is made on the mobile application platform through the registration interface firstly, such that the mobile application platform records information on the user who has performed the further forwarding operation.

Preferably, wherein, the first proportion is 600 thousandths.

Preferably, wherein, if a duration time of a package which has not been clicked on remains in an account of a user exceeds a time threshold, the package is dismissed; and if the package is clicked on within the time threshold, the proceeds enter the account of the user.

Preferably, wherein, the time threshold is a week.

The present invention has at least the following advantageous effects: by the mobile application setting a predetermined value, calculating purchase amounts of the users, selecting users within a predetermined range, and taking a portion of proceeds of the sales amount as rebate for the users, user satisfaction with the product may be improved, and consumption amount from the users may also be increased. After a user obtains a proceeds package, he needs to log on the mobile application and click on the proceeds package to practically obtain the proceeds of that day, thereby hits rate and popularity of the mobile application may be improved, which produces a promotion effect. All mobile applications belong to a same mobile application platform, so it is easy for management. After each transaction is completed, the mobile application platform deducts in advance a part of sales amount of each transaction to guarantee the rebates for the users in a predetermined range. The users may keep obtaining proceeds until the product is not on sale, so the product may be promoted for a long time at a low cost.

Additional advantages, objects and features of the present invention will be partly embodied through the following description, and partly understood by those skilled in the art through study and practice of the present invention.

### BRIEF DESCRIPTION OF THE DRAWINGS

FIG. 1 is a flow chart showing a method for sharing sale proceeds from an E-commerce seller of a mobile application.

### DETAILED DESCRIPTION

Hereinafter, the present invention is further described in detail in conjunction with accompany drawings, to enable those skilled in the art to practice the invention with reference to the contents of the description.

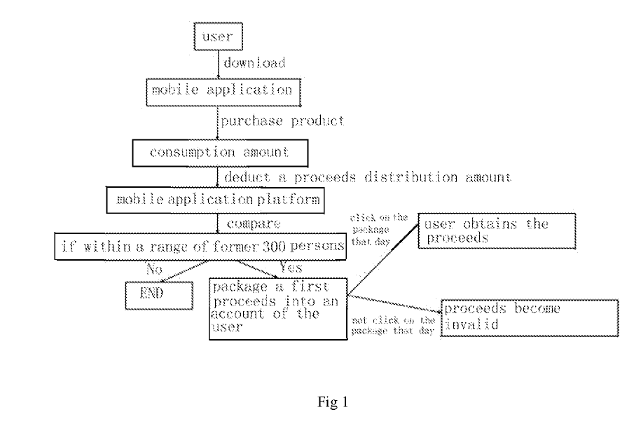

As illustrated in FIG. 1, a method for sharing sale proceeds from an E-commerce seller of a mobile application, comprising the following steps.

A sale request of a product from an E-commerce seller is presented through a mobile application on a mobile terminal such as a mobile phone, a notebook computer, a tablet computer, and the like. For example, a wine E-commerce seller has loaded product information of a wine onto a wine APP that needs to be downloaded by a user who intends to purchase the wine.

After the user of the mobile terminal downloads the mobile application, he purchases the product in the mobile application, and the mobile application calculates a cumulative amount of money spent by the user on the product. For example, the user intends to buy the wine priced at RMB 100 per bottle, and if the user purchases 200 bottles, the wine APP will record that a cumulative amount of money spent by the user is RMB 20,000.

When the cumulative amount reaches a predetermined value, a rank of the user compared with other users at a time the cumulative amount reaches the predetermined value is examined, and if the rank is within a predetermined range, a first proportion of sales amount of the product is taken as proceeds every day, and the proceeds are packaged into an account of the user in the mobile application. For example, the predetermined value is RMB 10,000, the user has bought RMB 20,000 of the wine, the rank of the user is 102th, and the wine APP will reward proceeds packages to former 300 users, the user may receive the first proportion of sales amount of the wine as proceeds that day.

Only if the user logs on the mobile application and clicks on the proceeds package every day, the user may finally obtain the proceeds, and the proceeds are recorded in the account in the mobile application. If the user does not click on the proceeds package, the user may not practically obtain the proceeds of that day. Only if the user logs on the mobile application and then clicks on the package that day, he may obtain the proceeds, and if the user does not click on the package that day, he may not obtain the proceeds, and the package will be invalid the next day and days after the next day.

Wherein, mobile applications of all E-commerce sellers belong to a same mobile application platform. A customer may not see the mobile application platform through a mobile terminal, and he may only download a mobile application which he needs. However, all mobile applications are uniformly managed by one mobile application platform in the background. The said mobile application platform deducts in advance a second proportion of a sales amount of each successful transaction from each E-commerce seller thereon, as a proceeds distribution amount, and then distributes the proceeds distribution amount to an account of each mobile application. Wherein, the second proportion is larger than the first proportion. Here, the first proportion is a fraction of the second proportion.

Wherein, the first proportion is ten thousandths; the predetermined range is former 300 persons; and the second proportion is three percent. For example, when a customer has spent RMB 100 on the wine, the mobile application platform deducts in advance three percent therefrom to distribute the amount to the former 300 customers in terms of purchase amount after sales of that day close, such that each of the former 300 customers may receive ten thousandths of the proceeds.

Wherein, if the cumulative purchase amount of the user on the product keeps within the former 300^{th} every day, and the purchase amount is within the prescribed predetermined value, the user may keep obtaining the proceeds until the product is not on sale any more.

A method for sharing sale proceeds from an E-commerce seller of a mobile application, comprising the following steps.

A sale request of a product from an E-commerce seller is represented through a mobile application on a mobile terminal such as a mobile phone, a notebook computer, a tablet computer, and the like. For example, a wine E-commerce seller has loaded product information of a wine onto a wine APP that needs to be downloaded by a user who intends to purchase the wine.

The user of the mobile terminal may forward the sale request to mobile applications of other types than that of the mobile application. For example, the user may forward the sale information of the wine to his WeChat or Microblog.

The sale request received by the mobile applications of other types contains a link to a sale interface for performing a direct purchase operation. For example, after the sale information of the wine is forwarded to the customer's Microblog, a link to a sale interface of the wine is contained in the sale information.

If a purchase transaction is successful, a first proportion of sales amount of the product is taken as proceeds, and the proceeds are packaged into an account of the user who has performed the forwarding operation in the mobile application. If a friend of the user clicks on the link through the user's Microblog or WeChat, enters a sale interface of the wine and purchase the wine, proceeds of 600 thousandths of the sales amount of the wine purchased by the friend is packaged into the account of the user in the mobile application.

If the user has downloaded a mobile application, only if the user logs on the mobile application and clicks on the proceeds package, the user may finally obtain the proceeds. If the user has forwarded a link which had been forwarded through Microblog or WeChat of others, the user may log on a background interface to click on the proceeds package. Finally, the proceeds are recorded in the account in the mobile application or the background interface. If the user does not click on the proceeds package, the user may not practically obtain the proceeds.

Wherein, mobile applications of all E-commerce sellers belong to a same mobile application platform. A customer may not see the mobile application platform through a mobile terminal, and he may only download a mobile application which he needs. When the user of the mobile terminal forwards the sale request, the said mobile application platform records information on the user who has performed the forwarding operation, so as to distribute proceeds to the user after a purchase transaction is successful.

Wherein, a sale request which has been forwarded to mobile applications of other types is forwarded further. After a purchase operation on a sale request that has been forwarded further, a first proportion of sales amount of the product is packaged as proceeds into an account of the user who has performed the further forwarding operation in the mobile application, and the user who has performed the first forwarding operation may not obtain the proceeds. For example, a customer forwards a sale request at a mobile terminal to his Microblog, and a friend of the customer forwards the Microblog further to his Microblog. Another person sees the sale request link on the Microblog of the friend of the customer, clicks on the link to enter a purchase interface and make a purchase successfully. Then the mobile application platform packages a first proportion of sales amount into an account of the friend of the customer in the mobile application, and the customer may not obtain the proceeds.

Wherein, the mobile application is provided with a functional model for directly forwarding to other mobile applications, for the user to forward to his Microblog or WeChat.

Wherein, the mobile applications of other types comprise WeChat and Microblog, and the user may forward a link of the sale request to both of the mobile applications.

Wherein, the sale request received by mobile applications of other types also contains a registration interface, and when a sale request which has been forwarded to mobile applications of other types is forwarded further, a registration is made on the mobile application platform through the registration interface firstly, such that the mobile application platform records information on the user who has performed the further forwarding operation.

Wherein, the first proportion is 600 thousandths. If a sales amount of the product that day is RMB 10,000, a package of the first proportion is RMB 60.

Wherein, if a duration time of a package which has not been clicked on remains in an account of a user exceeds a time threshold, the package is dismissed; and if the package is clicked on within the time threshold, the proceeds enter the account of the user.

Wherein, the time threshold is a week. After the forwarded link is clicked and through which a purchase is made, a package of the first proportion is put an account of the forwarder in the mobile application. There is a week time since the day of purchase for the forwarder to click on the package to receive the proceeds, after a week time elapse, the proceeds package is overdue and invalid.

Although the embodiments of the present invention have been disclosed as above, they are not limited merely to those set forth in the description and the embodiments, and they may be applied to various fields suitable for the present invention. For those skilled in the art, other modifications may be easily achieved, and the present invention is not limited to the particular details and illustrations shown and described herein, without departing from the general concept defined by the claims and their equivalents.

What is claimed is:

1. A method for sharing sale proceeds from an E-commerce seller of a mobile application, comprising:
presenting a sale request of a product from an E-commerce seller through a mobile application on a mobile terminal;
enabling a user of the mobile terminal to purchase the product in the mobile application, and calculating a cumulative amount of money spent by the user on the product through the mobile application;
when the cumulative amount reaches a predetermined value, examining a rank of the user compared with other users at a time the cumulative amount reaches the predetermined value, and if the rank is within a predetermined range, taking a first proportion of sales amount of the product as proceeds every day, and packaging the proceeds into an account of the user in the mobile application;
only if the user logs on the mobile application and clicks on the proceeds package every day, enabling the user to finally obtain the proceeds, and recording the proceeds in the account in the mobile application; and if the user does not click on the proceeds package, disabling the user to practically obtain the proceeds of that day.

2. The method for sharing sale proceeds from an E-commerce seller of a mobile application of claim 1, wherein, mobile applications of all E-commerce sellers belong to a same mobile application platform, and the said mobile application platform deducts in advance a second proportion of a sales amount of each successful transaction from each E-commerce seller thereon, as a proceeds distribution amount, and then distributes the proceeds distribution amount to an account of each mobile application, wherein, the second proportion is larger than the first proportion.

3. The method for sharing sale proceeds from an E-commerce seller of a mobile application of claim 2, wherein, the first proportion is ten thousandths; the predetermined range is former 300 persons; and the second proportion is three percent.

4. The method for sharing sale proceeds from an E-commerce seller of a mobile application of claim 2, wherein, the user is enabled to keep obtaining the proceeds until the product is not on sale any more.

5. A method for sharing sale proceeds from an E-commerce seller of a mobile application, comprising:
representing a sale request of a product from an E-commerce seller through a mobile application on a mobile terminal;
enabling the user of the mobile terminal to forward the sale request to mobile applications of other types than that of the mobile application;
the sale request received by the mobile applications of other types containing a link to a sale interface for performing a direct purchase operation;
if a purchase transaction is successful, taking a first proportion of sales amount of the product as proceeds, and packaging the proceeds into an account of the user who has performed the forwarding operation in the mobile application;
only if the user logs on the mobile application or a background interface and clicks on the proceeds package, enabling the user to finally obtain the proceeds, and recording the proceeds in the account in the mobile application or the background interface; and if the user does not click on the proceeds package, disabling the user to practically obtain the proceeds.

6. The method for sharing sale proceeds from an E-commerce seller of a mobile application of claim 5, wherein, mobile applications of all E-commerce sellers belong to a same mobile application platform, and when the user of the mobile terminal forwards the sale request, the said mobile application platform records information on the user who has performed the forwarding operation, so as to distribute proceeds to the user after a purchase transaction is successful.

7. The method for sharing sale proceeds from an E-commerce seller of a mobile application of claim 6, wherein, a sale request which has been forwarded to mobile applications of other types is forwarded further, after a purchase operation on a sale request that has been forwarded further, a first proportion of sales amount of the product is packaged as proceeds into an account of the user who has performed the further forwarding operation in the mobile application, and the user who has performed the first forwarding operation is disabled to obtain the proceeds.

8. The method for sharing sale proceeds from an E-commerce seller of a mobile application of claim 7, wherein, the mobile application is provided with a functional model for directly forwarding to other mobile applications.

9. The method for sharing sale proceeds from an E-commerce seller of a mobile application of claim 8, wherein, the mobile applications of other types comprise WeChat and Microblog.

10. The method for sharing sale proceeds from an E-commerce seller of a mobile application of claim 7, wherein, the sale request received by mobile applications of other types also contains a registration interface, and when a sale request which has been forwarded to mobile applications of other types is forwarded further, a registration is made on the mobile application platform through the registration interface firstly, such that the mobile application platform records information on the user who has performed the further forwarding operation.

11. The method for sharing sale proceeds from an E-commerce seller of a mobile application of claim 10, wherein, the first proportion is 600 thousandths.

12. The method for sharing sale proceeds from an E-commerce seller of a mobile application of claim 7, wherein, if a duration time of a package which has not been clicked on remains in an account of a user exceeds a time threshold, the package is dismissed; and if the package is clicked on within the time threshold, the proceeds enter the account of the user.

13. The method for sharing sale proceeds from an E-commerce seller of a mobile application of claim 12, wherein, the time threshold is a week.
